(19) United States
(12) Patent Application Publication
(10) Pub. No.: US 2026/0102989 A1
(43) Pub. Date: Apr. 16, 2026

(54) THERMOPLASTIC INTERLAYERS AND FILMS CONTAINING LUMINESCENT MATERIALS, AND SYSTEMS AND METHODS FOR THE SAME

(71) Applicant: DelStar Technologies, Inc., Alpharetta, GA (US)

(72) Inventors: Nandan Ukidwe, Suffield, CT (US); David Collette, South Hadley, MA (US); Alexander James Kidwell, Maple Grove, MN (US)

(21) Appl. No.: 19/357,220

(22) Filed: Oct. 14, 2025

Related U.S. Application Data
(60) Provisional application No. 63/707,342, filed on Oct. 15, 2024.

(51) Int. Cl. B32B 17/10; B32B 7/023

(52) U.S. Cl. CPC B32B 17/10669; B32B 7/023; B32B 17/10036; B32B 17/10614; B32B 17/1077; B32B 17/10917; B32B 17/10935; B32B 17/10449; B32B 2250/03; B32B 2250/40; B32B 2264/301; B32B 2305/30; B32B 2307/412; B32B 2307/422; B32B 2315/08; B32B 2375/00; B32B 2457/12

(57) ABSTRACT

Thermoplastic interlayers containing functional elements, such as quantum dots, laminates and systems incorporating the thermoplastic interlayers, and methods for the same are provided. The thermoplastic interlayer may be an extruded thermoplastic interlayer including a thermoplastic polyurethane and the functional elements disposed in the thermoplastic polyurethane. The functional elements may include quantum dots in an amount of from greater than 0 wt % to about 5 wt %. The thermoplastic interlayer may have a haze of from greater than 0% to less than or equal to 5%. The laminates may include first and second optically transparent outer sheets, and the thermoplastic interlayer interposed between the first and second optically transparent outer sheets. A laminated glazing unit is also provided and may include the laminate and a photovoltaic cell operably coupled with the laminate.

### CROSS-REFERENCE TO RELATED APPLICATIONS

This application claims the benefit of U.S. Provisional Application Ser. No. 63/707,342, filed Oct. 15, 2024, the complete disclosure of which is incorporated herein by reference for all purposes.

### TECHNICAL FIELD

This description generally relates to thermoplastic interlayers and films containing luminescent materials, laminates and systems incorporating the thermoplastic interlayers and films, and methods for the same.

### BACKGROUND

Laminated Glazing Units (LGUs) are laminated assemblies including one or more interlayers interposed between transparent rigid sheets. The rigid sheets can be glass or any other well-known substitute such as polycarbonates, acrylic resins, polyesters, and rigid transparent polyurethanes. The interlayer that bonds the rigid sheets with one another to form a unified laminated assembly may often be or include a thermoplastic material, such as polyvinyl formal, polyvinyl butyral, polyvinyl iso-butyral, silicone, or ethylene vinyl acetate (EVA). Recently, the performance demands on LGUs used in varying industries, such as the automotive and architectural industries, have expanded well beyond simple optical clarity and impact resistance. For example, LGUs have become a more significant component of commercial buildings and residential dwellings; often as an integral part of the structure itself. In such cases, the interlayer is increasingly expected to provide additional functionality (e.g., solar control, tinting, etc.) to reduce loads on building HVAC systems and improve cabin comfort and energy efficiency of vehicles. Additionally, as photovoltaic technologies advance, building integrating photovoltaics (BIPV) are gaining popularity as well. For example, LGUs are often modified for use as luminescent concentrators (LCs) and combined with photovoltaic cells to generate electricity.

Luminescent concentrators are devices that collect electromagnetic radiation (e.g., sunlight, solar radiation, etc.) for the purpose of generating electricity. For example, the luminescent concentrators may receive solar radiation over a relatively large area and act as a waveguide to concentrate the solar radiation onto a photovoltaic cell that subsequently converts the solar radiation into electricity. The luminescent concentrators often include luminescent materials, such as luminophores, that receive the solar radiation and emit light (e.g., fluorescence). The emitted light travels through the luminescent concentrator, which acts as a waveguide and directs the emitted light to the photovoltaic cell. While conventional luminescent concentrators and methods for the same have provided sufficient performance, recent trends have focused on improving their performance by reducing haze and/or increasing dispersion of the luminescent materials in one or more components thereof.

### SUMMARY

This following is intended merely to introduce a simplified summary of some aspects of one or more implementations of the subject matter discussed herein. Further areas of applicability of the subject matter will become apparent from the detailed description provided hereinafter. This summary is not an extensive overview, nor is it intended to identify key or critical elements of the present teachings, nor to delineate the scope of the subject matter. Rather, its purpose is merely to present one or more concepts in simplified form as a prelude to the detailed description below.

The foregoing and/or other aspects and utilities described herein may be achieved by providing an extruded thermoplastic interlayer including a thermoplastic polyurethane and functional elements disposed in the thermoplastic polyurethane. The functional elements may include quantum dots in an amount of from greater than 0 wt % to about 5 wt %, based on the total weight of the extruded thermoplastic interlayer. The extruded thermoplastic interlayer may have a haze, as determined according to reference test ASTM D1003, of from greater than 0% to less than or equal to about 10%.

In embodiments, the extruded thermoplastic interlayer may have a haze of from greater than 0% to less than 8%, or from greater than 0% to less than 6%, from greater than 0% to less than 5%, of from greater than 0% to less than 3%, or from greater than 0% to less than 2%.

In embodiments, the extruded thermoplastic interlayer may have a thickness of from about 254 μm to about 1524 μm, or from about 254 μm to about 508 μm.

In In embodiments, the extruded thermoplastic interlayer may have a thickness of about 381 μm.

In embodiments, the quantum dots may be present in an amount of from greater than 0 wt % to about 4 wt %, or greater than 0 wt % to about 3 wt %, or greater than 0 wt % to about 2 wt %, from greater than or equal to 0.1 wt % to about 1.5 wt %, or about 0.1% to about 1.0% based on the total weight of the extruded thermoplastic interlayer.

In embodiments, the extruded thermoplastic interlayer may exhibit visible light transmission, as measured according to reference test ASTM-D1003, of greater than or equal to 10%, or greater than or equal to 20%, or greater than or equal to 30%, or greater than or equal to 40%, or greater than or equal to 50% or greater than or equal to 60%.

In embodiments, the thermoplastic polyurethane may include a polyether-based thermoplastic polyurethane.

In embodiments, the polyether-based thermoplastic polyurethane is an aliphatic polyether thermoplastic polyurethane.

In embodiments, the thermoplastic polyurethane has one or more of: a tensile strength, as determined according to reference test ASTM D412, of from about 40 MPa to about 60 MPa; an elongation at break, as determined according to reference test ASTM D412, of from about 450% to about 500%; a 100% modulus, as determined according to reference test ASTM D412, of from about 3 MPa to about 4 MPa; a tear strength, as determined according to reference test ASTM D624, of from about 50 kN/m to about 60 kN/m; a glass transition temperature (Tg), as determined with a differential scanning calorimeter (DSC), of from about −65° C. to about −55° C.; a refractive index, as determined according to reference test ASTM D542-95, of from about 1 to about 2, about 1.25 to about 1.75; a haze, as determined according to reference test ASTM D1003, of from about 0% to about 1%, about 1% to about 0.5%; a yellow index, as determined according to reference test ASTM D1925, of less than or equal to about 1.5%; a visible transmission, as determined according to reference test ASTM D1003, of from about 80% to about 100%; and a thermomechanical analysis (TMA) peak of from about 85° C. to about 90° C.

The foregoing and/or other aspects and utilities described herein may be achieved by providing a laminate including a first optically transparent outer sheet, a second optically transparent optical sheet, and the extruded thermoplastic interlayer described. The extruded thermoplastic interlayer may be interposed between the first and second optically transparent outer sheets. The extruded thermoplastic interlayer may be configured to adhere the first and second optically transparent outer sheets with one another.

In embodiments, each of the first and second optically transparent outer sheets may be a glass sheet.

In embodiments, each of the first and second optically transparent outer sheets may be a polycarbonate sheet.

In embodiments, the laminate may have a quantum yield of greater than or equal to about 20%, greater than or equal to about 40%, greater than or equal to about 50%, greater than or equal to about 60%, greater than or equal to about 70%, greater than or equal to about 75%, greater than or equal to about 80%, greater than or equal to about 82%, greater than or equal to about 85%, or more.

In embodiments, the laminate may exhibit a quantum yield, as determined according to reference test ASTM E2719, of from about 50% to about 90%, or from about 70% to about 80%.

The foregoing and/or other aspects and utilities described herein may be achieved by providing a laminated glazing unit including the laminate described and a photovoltaic cell operably coupled with the laminate.

In embodiments, the photovoltaic cell may be disposed adjacent an end portion of the laminate.

The foregoing and/or other aspects and utilities described herein may be achieved by providing a window including the laminate described.

### BRIEF DESCRIPTION OF THE DRAWINGS

The accompanying drawings, which are incorporated in and constitute a part of this specification, illustrate several embodiments disclosed and, together with the description, serve to explain the principles thereof.

FIG. 1 is a schematic cross-sectional view of a laminated glazing unit including an exemplary laminated luminescent concentrator coupled with a photovoltaic cell, according to one or more implementations discussed herein.

### DETAILED DESCRIPTION

This description and the accompanying drawings illustrate exemplary embodiments and should not be taken as limiting, with the claims defining the scope of the present description, including equivalents. Various mechanical, compositional, structural, and operational changes may be made without departing from the scope of this description and the claims, including equivalents. In some instances, well-known structures and techniques have not been shown or described in detail so as not to obscure the description. Like numbers in two or more figures represent the same or similar elements. Furthermore, elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment. Moreover, the depictions herein are for illustrative purposes only and do not necessarily reflect the actual shape, size, or dimensions of the system or illustrated components.

It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Except as otherwise noted, any quantitative values are approximate whether the word “about” or “approximately” or the like are stated or not. The materials, methods, and examples described herein are illustrative only and not intended to be limiting.

As used throughout, ranges are used as shorthand for describing each and every value that is within the range. It should be appreciated and understood that the description in a range format is merely for convenience and brevity and should not be construed as an inflexible limitation on the scope of any embodiments or implementations discussed herein. Accordingly, the range should be construed to have specifically included all the possible subranges as well as individual numerical values within that range. As such, any value within the range may be selected as the terminus of the range. For example, description of a range such as from 1 to 5 should be considered to have specifically included subranges such as from 1.5 to 3, from 1 to 4.5, from 2 to 5, from 3.1 to 5, etc., as well as individual numbers within that range, for example, 1, 2, 3, 3.2, 4, 5, etc. This applies regardless of the breadth of the range.

Additionally, all numerical values are “about” or “approximately” the indicated value, and consider experimental error and variations that would be expected by a person having ordinary skill in the art. It should be appreciated that all numerical values and ranges discussed herein are approximate values and ranges, whether “about” is used in conjunction therewith. It should also be appreciated that the term “about,” as used herein, in conjunction with a numeral refers to a value that may be ±0.01% (inclusive), ±0.1% (inclusive), ±0.5% (inclusive), ≠1% (inclusive) of that numeral, ±2% (inclusive) of that numeral, ±3% (inclusive) of that numeral, ±5% (inclusive) of that numeral, ±10% (inclusive) of that numeral, or ±15% (inclusive) of that numeral. It should further be appreciated that when a numerical range is discussed herein, any numerical value falling within the range is also specifically included.

As used herein, the expression “free” of a material or a substance may refer to a composition, component, or phase where the material is present in an amount of less than 1.0 wt %, less than 0.1 wt %, less than 0.05 wt %, less than 0.01 wt %, less than 0.005 wt %, or less than 0.0001 wt %, based on a total weight of the composition, component, or phase. As used herein, the expression “substantially free” of a material or substance may refer to a composition, component, or phase where the material is present in an amount of about 1.0 wt % or more and less than 20.0 wt %, less than 10.0 wt %, less than 5.0 wt %, less than 3.0 wt %,

All references cited herein are hereby incorporated by reference in their entireties. In the event of a conflict in a definition with a cited reference, the present teachings control.

Thermoplastic interlayers and films containing functional elements (e.g., luminescent materials), laminates and systems (e.g., laminated glazing units) incorporating the thermoplastic interlayers and films, and methods for the same are described. The thermoplastic Interlayers for use with the laminates, and the laminates prepared therefrom, may be used in a variety of applications, such as windows for vehicles and buildings, impact resistance devices, such as bulletproof glass, decorative films for windows, walls or doors, window tinting, colored or mirrored glass, window films, or the like. The thermoplastic interlayers and thermoplastic films containing the luminescent materials may be particularly useful in, for example, applications requiring solar control functionality, such as windows that absorb and/or reflect heat, IR, and/or UV light, photovoltaic devices (e.g., solar cells), or the like, or a combination thereof. As used herein, the term or expression thermoplastic interlayer, thermoplastic film, or thermoplastic layer may be used interchangeably, and may only be distinguished from one another by their application, use, dimensions, and/or location. For example, a thermoplastic interlayer may have the same properties and/or dimensions as a thermoplastic film and a thermoplastic layer; however, the thermoplastic interlayer is disposed between two rigid sheets, while the thermoplastic film or the thermoplastic layer may be disposed in varying locations. As such, features and/or properties described with respect to a thermoplastic interlayer may be applicable to a thermoplastic film or a thermoplastic layer and vice versa. Illustrative systems that may utilize, incorporate, or otherwise include the thermoplastic interlayers and/or films containing the luminescent materials may be or include, but are not limited to, luminescent concentrators (LCs), laminated glazing units (LGUs), windows for vehicles and buildings, impact resistance devices (e.g., bulletproof glass), decorative films for windows, walls or doors, window tinting, colored or mirrored glass, window films, or the like, or any combination thereof.

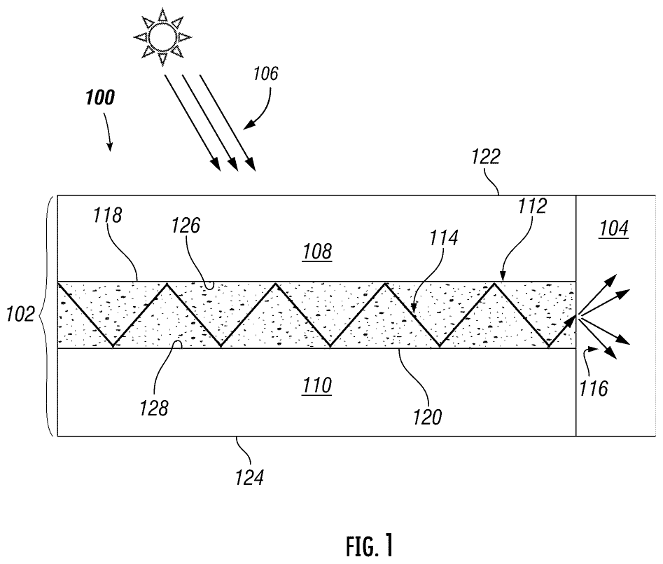

FIG. 1 is a schematic cross-sectional view of a laminated glazing unit 100 including an exemplary laminated luminescent concentrator (LC) 102 and a photovoltaic (PV) cell 104, according to one or more implementations. As illustrated in FIG. 1, the laminated luminescent concentrator 102 may be operably coupled with the photovoltaic cell 104. The laminated luminescent concentrator 102 may be capable of or configured to collect electromagnetic radiation 106 (e.g., sunlight) and direct or concentrate the electromagnetic radiation 106 to the photovoltaic cell 104 operably coupled therewith. The laminated luminescent concentrator 102 may also be capable of or configured to collect the electromagnetic radiation 106 (e.g., sunlight), convert a spectrum and photon flux of the collected electromagnetic radiation 106 into electromagnetic radiation 114 having a relatively narrower spectrum and a relatively higher photon flux via photoluminescence, and direct the electromagnetic radiation 114 to the photovoltaic cell 104. As used herein, the term photoluminescence may refer to the emission of light (e.g., electromagnetic radiation, photos, etc.) after the absorption of light or energy. Photoluminescence is one form of luminescence or light emission and is initiated by photoexcitation. Subsequent to photoexcitation, various charge relaxation processes may occur in which other photons having a relatively lower energy may be reradiated on a time scale. The energy difference between the absorbed photons and the emitted photons (e.g., the Stokes shift) may vary widely and may depend, at least in part, on the materials utilized. As used herein, the expression “photon flux” may refer to the number of photons passing through a unit of area per unit of time, and may conventionally be measured as counts per second per square meter. As used herein, the expression “Stokes shift” may refer to the difference in energy between the positions of the absorption shoulder or local absorption maximum and the maximum of the emission spectrum.

The photovoltaic cell 104 may be capable of or configured to receive the electromagnetic radiation 114 from the photovoltaic cell 104 and convert the electromagnetic radiation 114 into energy (e.g., electricity). The luminescent concentrator 102 may be utilized as a window or form a portion of a window of a building or a vehicle. In contrast to conventional solar panels or solar harvesting window concepts that utilize stacks of photovoltaic cells that cover the entire panel/window, the laminated glazing unit 100 utilizes a relatively narrow strip of the photovoltaic cell 104 disposed at or along one or more end portions or edges of the laminated glazing unit 100 or the luminescent concentrator 102 thereof.

As illustrated in FIG. 1, the laminated luminescent concentrator 102 may include a first outer layer, sheet, or ply 108, a second outer layer, sheet, or ply 110, and a thermoplastic interlayer 112 interposed between the first and second outer layers 108, 110. The thermoplastic interlayer 112 may be capable of or configured to adhere the first and second outer layers 108, 110 with one another. In at least one implementation, the thermoplastic interlayer 112 may be a monolithic structure or component including one or more thermoplastic polymers. As used herein, the term or expression “monolithic” refers to a single, substantially indivisible layer or film of material(s). It should be appreciated that the monolithic thermoplastic interlayer described herein may include one or more layers or regions of materials that are substantially indivisible or substantially inseparable. In another implementation, the thermoplastic interlayer 112 may include substantially divisible or substantially inseparable layers.

The outer layers 108, 110 may each include optically transparent and/or substantially rigid materials. Illustrative materials for the outer layers 108, 110 may be or include, but are not limited to, one or more of glass, artificial glass, or any well-known glass substitutes, such as polycarbonates, acrylic resins, polyesters, polyethers, laminated glass, polymeric sheets, ceramics, polyethylene terephthalates (PET), polyphosphonates, polyurethanes, a float, tempered, or chemically strengthened glass (e.g., borosilicate glass), or the like, or any combination thereof. In an exemplary implementation, the laminated glazing unit 100 or the luminescent concentrator (LC) 102 thereof utilizes glass. Glass may provide a flat and abrasion resistant surface that may be relatively more effective at waveguiding light or photons due in part to its higher index of refraction than air. Further, the manufacturing process utilized to prepare laminated glass (e.g., safety glass) may be utilized to produce the laminated glazing unit 100 or the luminescent concentrator 102. In addition, glass may exhibit relatively less absorption in the infrared region than polymers due in part to the absence of carbon-hydrogen bonds that have molecular vibration modes that may be excited in the wavelength range of from about 900 nm to about 1000 nm.

In at least one implementation, interfaces 118, 120 between respective surfaces of the first outer layer 108 and the second outer layer 110 and the thermoplastic interlayer 112 may be reflective or non-reflective. Each of the interfaces 118, 120 may be independently reflective or non-reflective. The interfaces 118, 120 may be reflective to wavelengths of light or electromagnetic radiation from one or more of the visible, infrared, and/or ultraviolet regions of the spectrum.

In at least one implementation, a coating (not shown) may be disposed on one or more respective surfaces 122, 124, 126, 128 of the outer layers 108, 110, and capable of or configured to at least partially reduce reflection of the electromagnetic radiation 106. For example, one or more respective surfaces 122, 124 of the first and second outer layers 108, 110 opposite surfaces 126, 128 in contact with the thermoplastic interlayer 112 may include a coating (not shown) capable of or configured to reduce reflection of the electromagnetic radiation 106. In another example, one or more respective surfaces 126, 128 of the first and second outer layers 108, 110 may include a coating (not shown) capable of or configured to reduce reflection of the electromagnetic radiation 106. In at least one implementation, the luminescent concentrator 102 may include one or more coatings (not shown) on the outer layers 108, 110 and/or the thermoplastic interlayer 112 capable of or configured to at least partially and/or selectively reflect electromagnetic radiation 114 emitted from the luminophores, thereby keeping the light internally reflected in the thermoplastic interlayer 112.

The thermoplastic interlayer 112 may include one or more functional elements contained, dispersed, mixed, or otherwise disposed therein. Illustrative functional elements may be or include, but are not limited to, solar control elements, luminophores, ionomers, other optical elements, such as ultraviolet (UV) absorbers, UV reflectors, infrared (IR) absorbers, IR reflectors, or the like, or any combination thereof. In an exemplary implementation, the thermoplastic interlayer 112 includes luminophores disposed therein. Luminophores may include substances (e.g., atoms, functional groups of a chemical compound, etc.) capable of emitting light upon excitation by an external energy source, such as electromagnetic radiation 106, ultraviolet radiation, electricity, or the like. Illustrative luminophores may be or include, but are not limited to, fluorescent dyes, phosphors, fluorophores, rare-earth ions, organic molecules, quantum dots (QDs), or the like, or any combination thereof. As used herein, a fluorophore may refer to a material that absorbs a first spectrum of light and emits a second spectrum of light, such as via luminescence or fluorescence.

In at least one implementation, the thermoplastic interlayer 112 may include the one or more functional elements (e.g., quantum dots) in an amount of from greater than 0 wt % to about 5 wt %, based on the total weight of the thermoplastic interlayer 112. For example, the thermoplastic interlayer 112 may include the one or more functional elements in an amount of from 0 wt %, about 0.5 wt %, about 1 wt %, about 1.5 wt %, about 2 wt %, or about 2.5 wt % to about 3 wt %, about 3.5 wt %, about 4 wt %, about 4.5 wt %, or about 5 wt %, based on the total weight of the thermoplastic interlayer 112.

In another implementation, the thermoplastic interlayer 112 may include the one or more functional elements (e.g., quantum dots) in an amount of from 0 wt % to about 2 wt %, based on the total weight of the thermoplastic interlayer 112. For example, the thermoplastic interlayer 112 may include the one or more functional elements in an amount of from 0 wt %, about 0.1 wt %, about 0.5 wt %, about 0.8 wt %, or about 1 wt % to about 1.2 wt %, about 1.5 wt %, about 1.8 wt %, or about 2.0 wt %. In another example, the thermoplastic interlayer 112 may include the one or more functional elements in an amount of from greater than 0 wt % to about 2 wt %, about 0.5 wt % to about 1.5 wt %, about 0.8 wt % to about 1.2 wt %, or about 1 wt %, based on the total weight of the thermoplastic interlayer 112.

In an exemplary implementation, the one or more functional elements of the thermoplastic interlayer 112 include quantum dots. As used herein, the expression “quantum dots” may refer to a nanoscale particle that, such as nanoscale semiconductor particles or colloidal semiconductor nanocrystals, that exhibit size-dependent electronic and optical properties due to quantum confinement. For example, quantum dots exhibit size-dependent emission wavelengths that allow precise tuning of emitted light colors by controlling their respective sizes during synthesis. It should be appreciated that as the respective sizes of the quantum dots increase, their absorption onset and photoluminescence spectra shift towards redder wavelengths. Similarly, as the respective sizes of the quantum dots decrease, their absorption onset and photoluminescent spectra shift towards bluer wavelengths. The overlap between the absorption and emission spectra at least partially contributes to self-absorption of their photoluminescence. As used herein, the expression “self-absorption” may refer to the percentage of emitted light from luminophores or fluorophores that is absorbed by the same luminophores or fluorophores, respectively. The quantum dots may be utilized as a solid form (e.g., powdered) or a solution (e.g., suspension, dispersion, etc.).

The quantum dots may have at least one dimension less than or equal to about 100 nanometers, less than or equal to 50 nm, or less than or equal to about 20 nm. The quantum dots may include colloidal quantum dots. For example, the quantum dots may be, remain in, or form a suspension when mixed, dispersed, disposed, or otherwise contacted with a medium (e.g., liquid medium). The quantum dots may be prepared, formed, or synthesized from a binary semiconductor material having a formula MX, where M may be a metal and X may be selected from one or more of sulfur, selenium, tellurium, nitrogen, phosphorus, arsenic, antimony, or any combination thereof. Illustrative binary quantum dots may be or include, but are not limited to, one or more of CdS, CdSe, CdTe, PbS, Pb Se, PbTe, ZnS, ZnSe, ZnTe, InP, InAs, Cu₂S, In₂S₃, or the like. The quantum dots may also be or include, but are not limited to, ternary, quaternary, and/or alloyed quantum dots, which may be utilized alone or in combination with the binary quantum dots. Illustrative ternary, quaternary, and/or alloy quantum dots may be or include, but are not limited to, one or more of ZnSSe, ZnSeTe, ZnSTe, CdSSe, CdSeTe, HgSSe, HgSeTe, HgSTe, ZnCdS, ZnCdSe, ZnCdTe, ZnHgS, ZnHgSe, ZnHgTe, CdHgS, CdHgSe, CdHgTe, ZnCdSSe, ZnHgSSe, ZnCdSeTe, ZnHgSeTe, CdHgSSe, CdHgSeTe, CuInS₂, CuInSe₂, CuInGaSe₂, CuInZnS₂, CuZnSnSe₂, CuIn(Se,S)₂, CuInZn(Se,S)₂, AgIn(Se,S)₂, or the like, or any combination thereof. In at least one implementation, the quantum dots may exclude one or more of cadmium, lead, mercury, or any combination thereof, thereby reducing health, environmental, and/or safety concerns of the quantum dots.

The quantum dots may be prepared from a single material, or a combination of materials. For example, the quantum dots may include a combination of materials in a core-shell configuration including an inner core and an outer shell. The thin outer shell may be formed or prepared according to conventional methods known in the art, such as cation exchange. The quantum dots may also include one or more ligands bound or otherwise coupled with a surface thereof. In an exemplary implementation, the quantum dots may be, include, or be composed of CuInSeₓS₂₋ₓ/ZnS core-shell quantum dots, which may have a relatively greater intrinsic Stokes shift. Illustrative core-shell quantum dots may also be or include, but are not limited to, one or more of CdSe/CdS, CdSe/ZnSe, CdSe/ZnS, CdSe/ZnTe, CdSe/CdTe, CdTe/CdSe, CdTe/CdS, CdTe/ZnSe, CdTe/ZnS, CdTe/ZnTe, CdS/ZnSe, CdS/ZnS, CdS/CdTe, CdS/CdSe, PbSe/PbS, PbS/PbSe, PbTe/PbS, PbS/PbTe, PbTe/PbSe, PbSe/PbTe, PbSe/CdSe, CdSe/PbTe, PbS/CdS, CdS/PbS, PbTe/CdTe, CdTe/PbTe, InAs/CdS, InSb/CdS, InP/CdS, InAs/CdSe, InSb/CdSe, InP/CdSe, InAs/ZnSe, InP/ZnSe, InSb/ZnSe, InAs/ZnS, InP/ZnS, InSb/ZnS, Ge/Si, Si/Ge, Sn/Si, Si/Sn, Ge/Sn, Sn/Ge, or the like, or any combination thereof.

The thermoplastic interlayer 112 may be extruded and assembled into a laminate, such as the luminescent concentrator 102. The thermoplastic interlayer 112 may be extruded by a single or two/double screw extruder, coated, cast, UV cured, or formed by other methods. In an exemplary implementation, the thermoplastic interlayer 112, including the functional elements, such as quantum dots, is extruded. Extrusion may include combining or otherwise contacting a thermoplastic polymer (e.g., thermoplastic polyurethane) and the functional elements (e.g., quantum dots) with one another in a screw extruder, dispersing the quantum dots in the thermoplastic polyurethane via the extruder, and extruding the thermoplastic polyurethane with the quantum dots through a die to form the thermoplastic interlayer 112 in the form of a flat film, sheet, or layer. It should be appreciated that the ability to utilize extrusion casting with the thermoplastic interlayer 112 significantly reduces the cost of preparing the luminescent concentrator 102 while concurrently providing the thermoplastic interlayer 112 with reduced (i.e., <10% or <5%), improved visible light transmission, and improved quantum yield.

The thermoplastic interlayer 112 may include one or more thermoplastic polymers. For example, the thermoplastic interlayer 112 may be or include a single thermoplastic polymer. In another example, the thermoplastic interlayer 112 may be or include a plurality of thermoplastic polymers. The plurality of thermoplastic polymers may be a homogenous or heterogenous mixture or blend thereof. The plurality of thermoplastic polymers may be a single-phase blend or a multi-phase blend. A single-phase blend of thermoplastic polymers may include a plurality of thermoplastic polymers that are miscible with one another and/or form a polymeric material, often with a single glass transition temperature (Tg) based on the ratio of the thermoplastic polymers. A multi-phase blend may include two or more thermoplastic polymers that are immiscible with one another and/or have a plurality of glass transition (Tg) temperatures. As used herein, the term or expression “thermoplastic polymer” may refer to a plastic capable of being repeatedly softened or melted by increases in temperature and hardened by decreases in temperature. The one or more thermoplastic polymers may be crystalline or semi-crystalline. A crystalline thermoplastic polymer may generally include no crosslinking to a modest amount of crosslinking relative to a thermoset polymer. The relative decreased amount of crosslinking has a correspondingly reduced influence on respective properties of the thermoplastic polymer, such as softening and/or melting. A thermoplastic polymer may also generally include a higher molecular weight polymer relative to a thermoset, as a relatively higher molecular weight may enhance one or more properties, such as melting point to enhance or facilitate the integrity of the thermoplastic during use.

The thermoplastic polymer may be present in the thermoplastic interlayer 112 in an amount of from greater than or equal to about 80 wt % to about 99.9 wt %, based on the total weight of the thermoplastic interlayer 112. For example, the thermoplastic polymer may be present in an amount of from greater than or equal to about 80 wt %, greater than or equal to about 85 wt %, greater than or equal to about 90 wt %, greater than or equal to about 95 wt %, greater than or equal to about 98 wt %, greater than or equal to about 98.5 wt %, greater than or equal to about 99 wt %, greater than or equal to about 99.5 wt %, or about 99.9 wt %. In an exemplary implementation, the thermoplastic interlayer 112 includes the thermoplastic polymer in an amount of from about 98 wt % to about 99.9 wt %, or about 99 wt %, based on the total weight of the thermoplastic interlayer 112.

The one or more thermoplastic polymers may have a molecular weight of from about 1,000 Da to about 250,000 Da or more. For example, any one or more of the thermoplastic polymers may have a molecular weight of from about 1,000 Da to about 250,000 Da, about 1,000 Da to about 200,000 Da, about 1,000 Da to about 150,000 Da, or about 1,000 Da to about 100,000 Da. In another example, any one or more of the thermoplastic polymers may have a molecular weight of from about 1,000 Da, about 2,000 Da, about 5,000 Da, about 10,000 Da, about 50,000 Da, or more to about 100,000 Da, about 150,000 Da, about 200,000 Da, about 250,000 Da, about 300,000 Da, about 350,000 Da, or more.

In an exemplary implementation, the thermoplastic polymer may be or include one or more thermoplastic elastomers. An elastomer may include a macromolecular material that may return rapidly to approximately the initial dimensions and/or shape after deformation by stress or a biasing force. The thermoplastic-based elastomer may be or include any one or more suitable thermoplastic elastomers. For example, the thermoplastic-based elastomer may be or include a single thermoplastic elastomer. In another example, the thermoplastic-based elastomer may be or include a plurality (e.g., two or more) of thermoplastic elastomers. The plurality of thermoplastic elastomers may be a homogenous or heterogeneous mixture or blend. The thermoplastic elastomer may have crosslinks capable of or configured to prevent permanent deformation during use via increased elasticity and/or decreased plasticity. The one or more thermoplastic elastomers may have one or more crosslinks about 4,000 to about 10,000 monomer units in the respective polymeric chain.

In an exemplary implementation, the thermoplastic interlayer 112 may include one or more thermoplastic polyurethanes and/or thermoplastic polyurethane elastomers. For example, the thermoplastic elastomer may be or include a blend of two or more thermoplastic polyurethanes and/or thermoplastic polyurethane elastomers. The thermoplastic polyurethane and/or thermoplastic polyurethane elastomer may include a block copolymer including a hard segment and a soft segment. The hard segment may include a polyisocyanate (e.g., diisocyanate), a chain extender, or a combination thereof. The chain extender may be or include, are not limited to, one or more of a polyol (e.g., a diol, a glycol, etc.), a polyfunctional amine (e.g., a primary amine, a secondary amine, or the like, or a combination thereof), or the like, or a combination thereof. For example, the chain extender may be or include, but is not limited to, one or more of a 1,4-butanediol, a glycol, a diol, an ethylene glycol, a diamine, or the like, or a combination thereof. The soft segment may include a long chain diol, a long chain elastomeric polyol, or a combination thereof. Illustrative long chain diols and long chain elastomeric polyols may be or include, but are not limited to, one or more of a polyether, a polyether polyol, a polcaprolactone polyester, a polyadipate polyester, a polytetramethylene glycol ether, a hydroxyl group end-capped monomer, a hydroxyl group end-capped, a polyester, a polyester polyol, or the like, or a combination thereof. Illustrative polyether polyols may be or include, but are not limited to, a diol and/or a triol having a molecular weight of from about 4,000 Da to about 6,000 Da or more. Illustrative polyesters may be or include, but are not limited to a polyester prepared from a glycol, such as an ethylene glycol, and an adipic acid having a molecular weight of from about 1,000 Da to about 3,000 Da and/or a poly(epsilon-caprolactone). Illustrative polyesters may also be or include, but are not limited to a polyester prepared from a polycarboxylic acid, such as a dicarboxylic acid (e.g., an adipic acid) and a polyol. The polyester may have a hydroxy moiety at one or more termini. In an exemplary implementation, the thermoplastic polyurethane and/or thermoplastic polyurethane elastomer may be a reaction product or prepared from reacting one or more diisocyanates with one or more long chain diols and/or the chain extender. The thermoplastic polyurethane and/or thermoplastic polyurethane elastomer may include one or more crosslinks.

It should be appreciated that the type of the soft segment polyol utilized to prepare the thermoplastic polyurethane and/or thermoplastic polyurethane elastomer may at least partially determine or facilitate the classification thereof. For example, the soft segment polyol of the thermoplastic polyurethane and/or thermoplastic polyurethane elastomer may classify the thermoplastic as a polyether-based thermoplastic, a polyester-based thermoplastic, a polycaprolactam-based thermoplastic, or the like. Particularly, a polyether polyol and a polyester polyol may be utilized as the polyol of the soft segment to prepare a polyether-based thermoplastic and a polyester-based thermoplastic, respectively. A polyester-based thermoplastic polyurethane may include, but is not limited to, a hydroxy terminated polyester polyol having a molecular weight of up to about 2,500 Da, about 3,000 Da, about 3,500 Da, about 4,000 Da, or more. The polyester-based thermoplastic polyurethane may be prepared by step growth and/or condensation polymerization, as is conventionally known in the art. The polyether polyol of a polyether-based thermoplastic polyurethane may be prepared using an epoxide by addition, ring opening, and/or anionic polymerization. The “hard segment” of the thermoplastic polyurethane elastomer may include a “chain extender” polyol, which may include a short chain diol, such as, a 1,4-butanediol, a 1,6-hexanediol, and/or an ethylene glycol, and a diisocyanate, such as, a 4,4′-diphenylmethane diisocyanate (MDI), a hydrogenated 4,4′-diphenylmethane diisocyanate (HMDI), a hexamethylene diisocyanate (HDI), a toluene diisocyanate (TDI), and/or a 1,5-diisocyanate, or the like, or any combination thereof. The hard segment may be capable of or configured to hydrogen bond with a different chain to promote or facilitate crystallization. Illustrative thermoplastic polyurethanes may be or include, but are not limited to, one or more of an aromatic polycaprolactam polyurethane, an aliphatic polycaprolactam polyurethane, an aromatic polyester-based thermoplastic polyurethane, a linear polyester-based thermoplastic polyurethane, an aliphatic polyester-based polyurethane, a linear polyether-based polyurethane, an aliphatic polyether-based polyurethane, an aromatic polyether-based polyurethane, or a combination thereof.

The thermoplastic interlayer 112 includes one or more of a polyether-based thermoplastic polyurethane, an aliphatic polyether thermoplastic polyurethane, a thermoplastic polyurethane resin blend, or the like, or any combination thereof. In an exemplary implementation, the thermoplastic interlayer 112 includes a polyether-based thermoplastic polyurethane. Illustrative polyether-based thermoplastic polyurethanes may be or include, but are not limited to, one or more of ESTANE AG-8451 TPU (an aliphatic polyether TPU commercially available from Lubrizol Corporation of Wickliffe, OH), TEXIN® 8980D (an aliphatic polyether TPU commercially available from Covestro, LLC), TECOFLEX® EG-72D (an aliphatic polyether TPU commercially available from Lubrizol Corporation of Wickliffe, OH), or the like, or any combination thereof.

In an exemplary implementation, the thermoplastic interlayer 112 includes ESTANE® AG-8451. The polyether-based thermoplastic polyurethane may have a specific gravity, as determined according to reference test ASTM D792 of the American Society for Testing and Materials (ASTM), of from about 1 g/cc to about 1.2 g/cc, or about 1.08 g/cc. The polyether-based thermoplastic polyurethane may have a tensile strength, as determined according to reference test ASTM D412, of from about 40 MPa to about 60 MPa, or about 48 MPa. The polyether-based thermoplastic polyurethane may have an elongation at break, as determined according to reference test ASTM D412, of from about 450% to about 500%, or about 475%. The polyether-based thermoplastic polyurethane may have a 100% modulus, as determined according to reference test ASTM D412, of from about 3 MPa to about 4 MPa, or about 3.45 MPa. The polyether-based thermoplastic polyurethane may have a tear strength, as determined according to reference test ASTM D624, of from about 50 kN/m to about 60 kN/m, or about 56 kN/m. The polyether-based thermoplastic polyurethane may have a glass transition temperature (Tg), as determined with a differential scanning calorimeter (DSC), of from about −65° C. to about −55° C., or about 60° C. The polyether-based thermoplastic polyurethane may have a refractive index, as determined according to reference test ASTM D542-95, of from about 1 to about 2, about 1.25 to about 1.75, or about 1.5. The polyether-based thermoplastic polyurethane may have a haze, as determined according to reference test ASTM D1003, of from about 0% to about 1%, about 1% to about 0.5%, or about 0.3%. The polyether-based thermoplastic polyurethane may have a yellow index, as determined according to reference test ASTM D1925, of less than or equal to about 1.5%, or less than or equal to about 1%. The polyether-based thermoplastic polyurethane may have a visible transmission, as determined according to reference test ASTM D1003, of from about 80% to about 100% or about 85% to about 95%. The polyether-based thermoplastic polyurethane may have a thermomechanical analysis (TMA) peak of from about 85° C. to about 90° C., or about 88° C. The polyether-based thermoplastic polyurethane may have a thermomechanical analysis (TMA) range of from about 65° C. to about 130° C.

In at least one implementation, the thermoplastic interlayer 112 includes one or more of a polyester-based thermoplastic polyurethane and/or an elastomer thereof. The polyester-based thermoplastic polyurethane and/or elastomer may be or include crystalline and/or semi-crystalline polymers. The plurality of polyester-based thermoplastic polyurethane and/or elastomer may include one or more of an aromatic polyester-based thermoplastic polyurethane, a linear polyester-based thermoplastic polyurethane, an aliphatic polyester-based polyurethane, an elastomer thereof, or a combination thereof. Illustrative polyester-based thermoplastic polyurethane and/or elastomer may be or include, but are not limited to, those commercially available from Lubrizol Corporation of Wickliffe, Ohio under the general designation ESTANE® and/or PEARLSTICK™. For example, the polyester-based thermoplastic polyurethane may be or include one or more of the following: ESTANE® 5701, which is a polyester-based polyurethane polymer; ESTANE® 5701 F1, which is an aromatic polyester-based polyurethane polymer; ESTANE® 5702, which is an aromatic polyester-based polyurethane polymer; ESTANE® 5703, which is an aromatic polyester based polyurethane polymer; ESTANE® 5707 F1, which is an aromatic polyester-based polyurethane polymer; ESTANE® 5712 F30, which is an aromatic polyester-based polyurethane polymer; ESTANE® 5713 F2, which is an aromatic polyester-based polyurethane; ESTANE® 58213 NAT, which is a polyester based thermoplastic polyurethane; ESTANE® 5715, which is an aromatic polyester-based thermoplastic polyurethane; PEARLSTICK® 5715 F2, which is an aromatic polyester-based thermoplastic polyurethane; PEARLSTICK® 5715, which is an aromatic polyester-based thermoplastic polyurethane, PEARLSTICK® 5701, which is a polyester-based thermoplastic polyurethane, or the like, or any combination thereof.

The thermoplastic interlayer 112 may have a thickness suitable for or sufficient to adhere the first and second outer layers 108, 110 with one another. For example, the thermoplastic interlayer 112 may have a thickness of at least about 254 μm (about 10 Mils) to about 1524 μm (about 60 Mils) or more. In an exemplary implementation, the thermoplastic interlayer 112 may have a thickness of from about 254 μm (about 10 Mils) to about 1524 μm (about 60 Mils) or more, about 254 μm (about 10 Mils) to about 1015 μm (40 Mils), about 254 μm (about 10 Mils) to about 762 μm (about 30 Mils), about 254 μm (about 10 Mils) to about 508 μm (about 20 Mils), or about 381 μm (about 15 Mils). In another example, the thermoplastic interlayer 112 may have a thickness of from about 254 μm, about 381 μm, or about 508 μm to about 762 μm, about 1015 μm, about 1270 μm, or about 1524 μm. In an exemplary implementation, the thermoplastic interlayer 112 has a thickness of from about 254 μm (about 10 Mils) to about 508 μm (about 20 Mils) or about 381 μm (about 15 Mils). It should be appreciated that the thickness may be determined according to conventional methods. For example, the thickness may be determined with a micrometer.

The thermoplastic interlayer 112 may include an adhesion promoter capable of or configured to enhance the coupling, bonding, or adhesion between the outer layers 108, 110 and the thermoplastic interlayer 112, and prevent delamination from the outer layers 108, 110. Illustrative adhesion promoters may be or include, but are not limited to, organosilanes, organotitanates, zirconates, zircoaluminates, alkyl phosphate esters, metal organics, or the like, or a combination thereof.

The thermoplastic interlayer 112 may have an index of refraction that may be within about 30% of the index of refraction of the outer layers 108, 110. For example, the thermoplastic interlayer 112 may have an index of refraction that is within about 30% or less, about 25% or less, about 20% or less, about 15% or less, or about 10% or less of the index of refraction of the outer layers 108, 110 (e.g., glass).

The laminated glazing unit 100, the luminescent concentrator 102, the thermoplastic interlayer 112 thereof, or any combination thereof may be at least partially transparent or at least semi-transparent. For example, any one of the laminated glazing unit 100, the luminescent concentrator 102, the thermoplastic interlayer 112, or any combination thereof may have a light transmission or visible light transmission (VLT), as measured according to reference test ASTM-D1003 of the American Society for Testing and Materials (ASTM), of greater than or equal to about 30%, greater than or equal to about 50%, greater than or equal to about 70%, greater than or equal to about 75%, greater than or equal to 80%, greater than or equal to 82%, greater than or equal to 84%, greater than or equal to 86%, greater than or equal to 88%, greater than or equal to 90%, or greater than or equal to 95%. The laminated glazing unit 100, the luminescent concentrator 102, the thermoplastic interlayer 112, or any combination thereof may at least partially filter visible light to thereby avoid imparting unnatural color to the transmitted light.

The laminated glazing unit 100, the luminescent concentrator 102, the thermoplastic interlayer 112, or any combination thereof may have an ultraviolet to visible spectrum transmission (UV-VIS), as measured with a UV-VIS spectrophotometer, of less than or equal to about 10%, less than or equal to about 5%, or less than or equal to about 1%.

The laminated glazing unit 100, the luminescent concentrator 102, the thermoplastic interlayer 112, or any combination thereof may have a haze, as measured according to reference test ASTM-D1003, of greater than or equal to 0% and less than or equal to about 10%. For example, any one of the laminated glazing unit 100, the luminescent concentrator 102, the thermoplastic interlayer 112 thereof, or any combination thereof may have haze, as measured according to ASTM-D1003 of from 0% to less than or equal to about 10%, less than or equal to about 8%, less than or equal to about 6%, less than or equal to about 5%, less than or equal to about 4%, less than or equal to about 3%, less than or equal to about 2%, or less than or equal to about 1%.

In an exemplary implementation, the laminated glazing unit 100, the luminescent concentrator 102, the thermoplastic interlayer 112, or any combination thereof may include non-carcinogenic quantum dots having a tunable photoluminescent spectra including peaks in the visible (e.g., about 400 nm to about 650 nm) to near-infrared region (e.g., about 650 nm to about 1400 nm. The laminated glazing unit 100 or the luminescent concentrator 102 may have a relatively large Stokes shift that limits self-absorption, thereby enabling the photoluminescence to be guided over relatively larger distances of from about 1 mm to about 10 m.

The luminescent concentrator 102 may have or exhibit, upon excitation with a source of light or a source of electromagnetic radiation, a quantum yield of greater than or equal to about 20%. For example, the luminescent concentrator 102 may have a quantum yield of greater than or equal to about 20%, greater than or equal to about 40%, greater than or equal to about 50%, greater than or equal to about 60%, greater than or equal to about 70%, greater than or equal to about 75%, greater than or equal to about 80%, greater than or equal to about 82%, greater than or equal to about 85%, or more. In another example, the luminescent concentrator 102 may have a quantum yield of from about 50% to about 90%, about 55% to about 85%, about 60% to about 80%, about 70% to about 80%, or about 75%. As used herein, the expression “quantum yield” may refer to the ratio of the number of photons emitted to the number of photons absorbed for a luminophore or a fluorophore. It should be appreciated that the quantum yield may be determined according to conventional methods.

The luminescent concentrator 102 or the luminophore thereof may have a relatively low self-absorption such that the photoluminescence is absorbed by less than 50% across the integrated spectrum by the luminophores disposed in the thermoplastic interlayer 112 thereof over distances of from about 1 mm to about 10 meters. It should be appreciated that self-absorbance allows light to leak or escape from total internal reflection; thus, reducing its relative concentration or flux at respective edges of the luminescent concentrator 102.

The luminescent concentrator 102 in combination with the photovoltaic cell 104, or the laminated glazing unit 100 including the luminescent concentrator 102 and the photovoltaic cell 104, may be capable of or configured to convert light or electromagnetic radiation 114 (e.g., sunlight) into electricity. In at least one implementation, the light or electromagnetic radiation 114 may be partially absorbed by less than or equal to about 50% across the integrated incident light spectrum. In another implementation, the light or electromagnetic radiation 114 may be mostly absorbed by more than 50% across the integrated incident light spectrum.

In an exemplary operation of the laminated glazing unit 100 and the luminescent concentrator 102, with continued reference to FIG. 1, the electromagnetic radiation 106, having an associated spectrum and photon flux, impinges on the luminescent concentrator 102. The thermoplastic interlayer 112 includes fluorophores, namely quantum dots, dispersed or otherwise disposed therein, which receive or absorb at least 1%, at least 5%, at least 10%, at least 15%, at least 20%, at least 50%, at least 70%, or more of the electromagnetic radiation 106 or the incident visible light of the electromagnetic radiation 106 and emit the electromagnetic radiation 114 having a new spectrum via luminescence. The electromagnetic radiation 114 may then be waveguided in a direction parallel or substantially parallel to the outer layers 108, 110 and towards the photovoltaic cell 104. The electromagnetic radiation 114, upon reaching an edge of the luminescent concentrator 102, may exit the luminescent concentrator 102 with a photon flux 116 that may be relatively greater than the incident photon flux of the electromagnetic radiation 114. The photon flux 116 may be directed to the photovoltaic cell 104 for the generation of electricity. It should be appreciated that the photon flux 116 may also be or alternatively be utilized for another process or purpose.

In at least one implementation, the laminated glazing unit 100, the luminescent concentrator 102, and/or the thermoplastic interlayer 112 may be utilized in the preparation or fabrication of a multilayer laminate or multilayer laminate assembly, such as an insulated glass unit (IGU), a window, a windshield, or the like. For example, the laminated glazing unit 100, the luminescent concentrator 102, and/or the thermoplastic interlayer 112 may be utilized in the preparation or fabrication of windows for vehicles and buildings, impact resistance devices, such as bulletproof glass, decorative films for windows, walls or doors, window tinting, colored or mirrored glass, window films, or the like. Exemplary multilayer assemblies may include the laminated glazing unit 100, the luminescent concentrator 102, and/or the thermoplastic interlayer 112, and may further include one or more electrochromic assemblies, photovoltaic assemblies or photovoltaic cells.

In an exemplary implementation, the thermoplastic interlayer 112 of the luminescent concentrator (LC) includes at least a combination of one or more thermoplastic polyurethanes (TPU) and the quantum dots described herein. The quantum dots may be present in an amount of from greater than 0 wt % to about 5%, based on the total weight of the thermoplastic interlayer 112. The luminescent concentrator (LC) 102 or the thermoplastic interlayer 112 thereof may have a haze of from greater than 0% to less than or equal to 5%, less than or equal to about 3%, or less than or equal to 2%, visible light transmission (VLT) of greater than or equal to 30%, greater than or equal to 50%, or greater than or equal to 70%, or more, and a quantum yield of greater than or equal to about 70%, greater than or equal to about 75%, greater than or equal to about 80%, greater than or equal to about 82%, greater than or equal to about 85%, or more.

### EXAMPLES

The examples and other implementations described herein are exemplary and not intended to be limiting in describing the full scope of compositions and methods described herein. Equivalent changes, modifications, and variations of specific implementations, materials, compositions, and methods may be made within the scope of the implementations or embodiments described herein, with substantially similar results.

### Example 1

Exemplary thermoplastic interlayers (1)-(14) including quantum dots were prepared under varying conditions and evaluated. Particularly, the exemplary thermoplastic interlayers (1)-(14) were prepared by combining about 98.9 wt % of a thermoplastic polyurethane resin and about 1.1 wt % of quantum dots with one another in a twin screw extruder. The thermoplastic polyurethane resin was an aliphatic polyether thermoplastic polyurethane, namely, ESTANE® AG-8451 TPU, which was commercially available from Lubrizol Corporation of Wickliffe, OH. The quantum dots were supplied by UbiQD, Inc. of Los Alamos, NM, and were utilized in powdered or liquid form. The average temperature for all of the zones of the extruder, the gauge (in mils) and the rotational speed (RPM) of the extruder for each sample are provided in Table 1. The thermoplastic interlayers (1)-(14) were evaluated for haze and visible light transmission (VLT). The results are summarized in Table 1.

TABLE 1

| Thermoplastic | Temp | | Gauge | VLT | Haze |
|---|---|---|---|---|---|
| Interlayer | ° F. | RPM | (Mil) | (%) | (%) |
| (1) | 300 | 254 | 13.5-15.8 | 36.9 | 10.8 |
| (2) | 300 | 254 | 12.0-14.0 | 40.5 | 9.81 |
| (3) | 300 | 255 | 11.75-13.5 | 42.1 | 9.15 |
| (4) | 290 | 335 | 14.0-16.0 | 51.7 | 6.79 |
| (5) | 290 | 335 | 12.0-14.6 | 39.8 | 7.56 |
| (6) | 290 | 335 | 12.0-14.5 | 42.2 | 6.2 |
| (7) | 290 | 335 | 10.5-11.5 | 50.2 | 4.54 |
| (8) | 300 | 254 | 13.5-15.8 | 37 | 10.4 |
| (9) | 300 | 254 | 12.0-14.0 | 43 | 9.17 |
| (10) | 290 | 255 | 11.75-13.5 | 44.6 | 8.5 |
| (11) | 290 | 335 | 14.0-16.0 | 40.7 | 6.83 |
| (12) | 290 | 335 | 12.0-14.6 | 40.6 | 7.59 |
| (13) | 290 | 335 | 12.0-14.5 | 40.9 | 6.21 |
| (14) | 290 | 335 | 10.5-11.5 | 52.2 | 4.25 |

As indicated in Table 1, all of the thermoplastic interlayers exhibited a haze (ASTM-D1003) of less than about 10% and a visible transmission (ASTM D1003) of greater than 35%. The thermoplastic interlayers (7) and (14), however, surprisingly and unexpectedly exhibited haze of less than 5% and visible light transmission of greater than 50%. It should be appreciated that the quantum dots and the thermoplastic polyurethane resin were combined with one another under conditions resulting in relatively lower or reduced shear. In particular, it is noted that the haze values decreased when the temperature was decreased from 300° F. to 290° F. and the RPM was increased from around 255 to about 335. The results were both surprising and unexpected, as conditions that result in relatively lower or reduced shear typically result in low or poor dispersion of nanoparticles, such as quantum dots, and relatively greater haze. However, it was discovered that utilizing low shear conditions when combining quantum dots with the thermoplastic polyurethane actually resulted in improved or lower haze and increased dispersion of the quantum dots.

Without being bound by theory, it is believed that relatively high shear conditions may result in shear thinning or lowering the viscosity of the thermoplastic polyurethane, and the shear thinning causes the quantum dots to experience low to no resistance; and thus, poor dispersion. Conversely, when reduced shear conditions are utilized, shear thinning of the thermoplastic polyurethane is reduced or eliminated and the quantum dots experience increased resistance in the polymer and improved dispersion.

It should be appreciated that similar thermoplastic interlayers were prepared under the foregoing conditions, but utilizing ethylene co-vinyl acetate (EVA) instead of the thermoplastic polyurethane. Accordingly, about 98.9 wt % of the ethylene co-vinyl acetate resin and about 1.1 wt % of quantum dots were combined with one another in a twin screw extruder. None of the thermoplastic interlayers utilizing ethylene co-vinyl acetate were able to achieve a haze of less than 5% and visible light transmission of greater than 50%.

### Example 2

Thermoplastic interlayers including quantum dots were prepared under relatively low shear conditions and laminated between two rigid sheets to prepare exemplary luminescent concentrators (LC) (15)-(26). Particularly, the thermoplastic interlayers were prepared by combining about 98.9 wt % of a thermoplastic polyurethane resin and about 1.1 wt % of quantum dots with one another in a twin screw extruder under relatively low shear conditions. The thermoplastic polyurethane resin and the quantum dots were the same as those utilized in Example 1. The sample sizes were 3″×3″. The first three interlayers (1)-(3) were produced with quantum dot powder and solid resin feed and the last eight interlayers (5)-(12) were produced with liquid quantum dots and solid resin feed. The liquid was fed at a rate between about 0.264 lbs/hour to about 0.318 lbs/hour. The fourth interlayer (4) was produced by delivering liquid quantum dot power at the feed throat of the extruder.

The resulting thermoplastic interlayers were then laminated or disposed between two rigid glass sheets via extrusion to prepare the exemplary luminescent concentrators (LC) (15)-(26). The average temperature for all of the zones of the extruder, gauge (in mils) and the rotational speed (RPM) of the extruder for each sample are provided in Table 1. Each of the exemplary luminescent concentrators (LC) (15)-(26) were evaluated for visible light transmission (VLT), and haze. The results are summarized in Table 2.

TABLE 2

| Thermoplastic | Temp | | Gauge | VLT | Haze |
|---|---|---|---|---|---|
| Interlayer | ° F. | RPM | (Mil) | (%) | (%) |
| (1) | 290 | 348 | 17.0-15.0 | 34.7 | 6.67 |
| (2) | 290 | 288 | 17.5-19.0 | 29.2 | 8.24 |
| (3) | 280 | 350 | 15.0-18.0 | 35.1 | 9.05 |
| (4) | 290 | 334 | 13.0-15.0 | 50.4 | 4.48 |
| (5) | 290 | 352 | 13.0-15.5 | 42.8 | 7.88 |
| (6) | 280 | 352 | 13.0-15.5 | 44.6 | 7.64 |
| (7) | 280 | 350 | 14.0-17.0 | 42.4 | 7.12 |
| (8) | 260 | 350 | 14.0-17.0 | 52.8 | 3.93 |
| (9) | 320 | 335 | 13.5-15.5 | 41.4 | 8.21 |
| (10) | 320 | 251 | 13.0-14.5 | 44.7 | 5.95 |
| (11) | 320 | 206 | 14.0-17.0 | 39.1 | 5.66 |
| (12) | 320 | 193 | 15.0-17.0 | 40.2 | 5.5 |

As indicated in Table 2, all of the thermoplastic interlayers exhibited haze (ASTM-D1003) of less than about 9% and a visible transmission (ASTM D1003) of greater than about 29%. The thermoplastic interlayers (4), (8) and (10)-(12), however, surprisingly and unexpectedly exhibited haze of less than about 6% and visible light transmission of greater than about 39%. All of the samples produced from liquid quantum dots exhibited haze of less than about 8.2% and visible light transmission of greater than about 39%. It is notable that interlayers (10)-(12), which demonstrated superior results, were manufactured at higher temperatures (about 320° F.) and lower RPMs (about 193 RPM to about 251 RPM). Thus, Applicant discovered that manufacturing the interlayers at temperatures above 300° F. (about 320° F.) with lower extruder RPMs below 280 RPM or about 251 RPM to about 193 RPM results in lower haze (below 6%) and higher visible light transmission (above 39%).

### Example 3

Thermoplastic interlayers including quantum dots were prepared under relatively low shear conditions and laminated between two rigid sheets to prepare exemplary luminescent concentrators (LC) (15)-(26). Particularly, the thermoplastic interlayers were prepared by combining about 98.9 wt % of a thermoplastic polyurethane resin and about 1.1 wt % of quantum dots with one another in a twin screw extruder under relatively low shear conditions. These interlayers were prepared under the same conditions as the interlayers shown above in Example 2 except that the sample sizes were 1″×3″. The first three interlayers (1)-(3) were produced with quantum dot powder and solid resin feed and the last eight interlayers (5)-(12) were produced with liquid quantum dots and solid resin feed. The liquid was fed at a rate between about 0.264 lbs/hour to about 0.318 lbs/hour. The fourth interlayer (4) was produced by delivering liquid quantum dot power at the feed throat of the extruder.

The resulting thermoplastic interlayers were then laminated or disposed between two rigid glass sheets via extrusion to prepare the exemplary luminescent concentrators (LC) (15)-(26). The average temperature for all of the zones of the extruder, gauge (in mils) and the rotational speed (RPM) of the extruder for each sample are provided in Table 1. Each of the exemplary luminescent concentrators (LC) (15)-(26) were evaluated for visible light transmission (VLT), and haze. The results are summarized in Table 3.

TABLE 3

| Thermoplastic | Temp | | Gauge | VLT | Haze |
|---|---|---|---|---|---|
| Interlayer | ° F. | RPM | (Mil) | (%) | (%) |
| (1) | 290 | 348 | 15.0 | 34.9 | 6.6 |
| (2) | 290 | 288 | 17.0-18.0 | 30.1 | 8.04 |
| (3) | 280 | 350 | 17.0-18.0 | 34.9 | 9.33 |
| (4) | 290 | 334 | 14.0-14.6 | 44 | 5.05 |
| (5) | 290 | 352 | 14.5 | 45 | 7.48 |
| (6) | 280 | 352 | 15.0 | 44.6 | 7.87 |
| (7) | 280 | 350 | 15.8-16.4 | 45 | 6.77 |
| (8) | 260 | 350 | 16.5-17.0 | 43 | 5.27 |
| (9) | 320 | 335 | 15 | 51.4 | 6.5 |
| (10) | 320 | 251 | 14.0-15.0 | 51.5 | 4.92 |
| (11) | 320 | 206 | 15.0-16.0 | 47 | 4.83 |
| (12) | 320 | 193 | 15.0-15.5 | 44.2 | 4.91 |

As indicated in Table 3, all of the thermoplastic interlayers exhibited haze (ASTM-D1003) of less than about 9.3% and a visible transmission (ASTM D1003) of greater than about 30%. The thermoplastic interlayers (4), (8) and (10)-(12), however, surprisingly and unexpectedly exhibited haze of less than about 5% and visible light transmission of greater than about 43%. All of the samples produced from liquid quantum dots exhibited haze of less than about 8% and visible light transmission of greater than about 43%. It is notable that interlayers (10)-(12), which demonstrated superior results, were manufactured at higher temperatures (about 320° F.) and lower RPMs (about 193 RPM to about 251 RPM). Thus, Applicant discovered that manufacturing the interlayers at temperatures above 300° F. (about 320° F.) with lower extruder RPMs below 280 RPM or about 251 RPM to about 193 RPM results in lower haze (below 5%) and higher visible light transmission (above 44.1%).

The foregoing demonstrates and supports the ability to prepare luminescent concentrators and thermoplastic interlayers thereof that exhibit surprising and unexpected reduction in haze and improved VLT. The luminescent concentrators and the thermoplastic interlayers thereof appear to rely on the particular combination of the quantum dots with a thermoplastic urethane, as other polymers, such as ethylene co-vinyl acetate (EVA) do not appear to demonstrate similar properties.

While the devices, systems, and methods have been described in detail herein in accordance with certain preferred implementations thereof, many modifications and changes therein may be affected by those skilled in the art. Accordingly, the foregoing description should not be construed to be limited thereby but should be construed to include such aforementioned obvious variations and be limited only by the spirit and scope of the following claims.

For example, in a first aspect, a first embodiment is an extruded thermoplastic interlayer, comprising a thermoplastic polyurethane and functional elements disposed in the thermoplastic polyurethane, wherein the functional elements comprise quantum dots in an amount of from greater than 0 wt % to about 5 wt %, based on the total weight of the extruded thermoplastic interlayer, and wherein the extruded thermoplastic interlayer has a haze, as determined according to reference test ASTM D1003, of from greater than 0% to less than or equal to about 10%.

A second embodiment is the first embodiment, wherein the extruded thermoplastic interlayer has a haze of from greater than 0% to less than 8%, or less than about 6% or less than about 5%.

A third embodiment is any combination of the first two embodiments, wherein the extruded thermoplastic interlayer has a haze of from greater than 0% to less than 3%.

A 4^{th} embodiment is any combination of the first 3 embodiments, wherein the extruded thermoplastic interlayer has a haze of from greater than 0% to less than 2%.

A 5^{th} embodiment is any combination of the first 4 embodiments, wherein the extruded thermoplastic interlayer has a thickness of from about 254 μm to about 1524 μm.

A 6^{th} embodiment is any combination of the first 5 embodiments, wherein the extruded thermoplastic interlayer has a thickness of from about 254 μm to about 508 μm.

A 7^{th} embodiment is any combination of the first 6 embodiments, wherein the extruded thermoplastic interlayer has a thickness of about 381 μm.

An 8^{th} embodiment is any combination of the first 7 embodiments, wherein the quantum dots are present in an amount of from greater than 0 wt % to about 4 wt %, based on the total weight of the extruded thermoplastic interlayer.

A 9^{th} embodiment is any combination of the first 8 embodiments, wherein the quantum dots are present in an amount of from greater than 0 wt % to about 3 wt %, based on the total weight of the extruded thermoplastic interlayer.

A 10^{th} embodiment is any combination of the first 9 embodiments, wherein the quantum dots are present in an amount of from greater than 0 wt % to about 2 wt %, based on the total weight of the extruded thermoplastic interlayer.

An 11^{th} embodiment is any combination of the first 10 embodiments, wherein the quantum dots are present in an amount of from greater than or equal to 0.1 wt % to about 1.5 wt %, based on the total weight of the extruded thermoplastic interlayer.

A 12^{th} embodiment is any combination of the first 11 embodiments, wherein the quantum dots are present in an amount of from greater than or equal to 0.1 wt % to about 1.0 wt %, based on the total weight of the extruded thermoplastic interlayer.

A 13^{th} embodiment is any combination of the first 3 embodiments, wherein the extruded thermoplastic interlayer exhibits visible light transmission, as measured according to reference test ASTM-D1003, of greater than or equal to 10%.

A 14^{th} embodiment is any combination of the first 13 embodiments, wherein the extruded thermoplastic interlayer exhibits visible light transmission, as measured according to reference test ASTM-D1003, of greater than or equal to 20%.

A 15^{th} embodiment is any combination of the first 14 embodiments, wherein the extruded thermoplastic interlayer exhibits visible light transmission, as measured according to reference test ASTM-D1003, of greater than or equal to 40%.

A 16^{th} embodiment is any combination of the first 15 embodiments, wherein the extruded thermoplastic interlayer exhibits visible light transmission, as measured according to reference test ASTM-D1003, of greater than or equal to 50%.

A 17^{th} embodiment is any combination of the first 16 embodiments, wherein the extruded thermoplastic interlayer exhibits visible light transmission, as measured according to reference test ASTM-D1003, of greater than or equal to 60%.

An 18^{th} embodiment is any combination of the first 17 embodiments, wherein the thermoplastic polyurethane comprises a polyether-based thermoplastic polyurethane.

A 19^{th} embodiment is any combination of the first 18 embodiments, wherein the polyether-based thermoplastic polyurethane is an aliphatic polyether thermoplastic polyurethane.

A 20^{th} embodiment is any combination of the first 19 embodiments, wherein the thermoplastic polyurethane comprises a tensile strength, as determined according to reference test ASTM D412, of from about 40 MPa to about 60 MPa.

A 21^{st} embodiment is any combination of the first 20 embodiments, wherein the thermoplastic polyurethane comprises an elongation at break, as determined according to reference test ASTM D412, of from about 450% to about 500%.

A 22^{nd} embodiment is any combination of the first 21 embodiments, wherein the thermoplastic polyurethane comprises a 100% modulus, as determined according to reference test ASTM D412, of from about 3 MPa to about 4 MPa.

A 23^{rd} embodiment is any combination of the first 22 embodiments, wherein the thermoplastic polyurethane comprises a tear strength, as determined according to reference test ASTM D624, of from about 50 kN/m to about 60 kN/m.

A 24^{th} embodiment is any combination of the first 23 embodiments, wherein the thermoplastic polyurethane comprises a glass transition temperature (Tg), as determined with a differential scanning calorimeter (DSC), of from about −65° C. to about −55° C.

A 25^{th} embodiment is any combination of the first 24 embodiments, wherein the thermoplastic polyurethane comprises a refractive index, as determined according to reference test ASTM D542-95, of from about 1 to about 2, about 1.25 to about 1.75.

A 26^{th} embodiment is any combination of the first 25 embodiments, wherein the thermoplastic polyurethane comprises a haze, as determined according to reference test ASTM D1003, of from about 0% to about 1%, about 1% to about 0.5%.

A 27^{th} embodiment is any combination of the first 26 embodiments, wherein the thermoplastic polyurethane comprises a yellow index, as determined according to reference test ASTM D1925, of less than or equal to about 1.5%.

A 28^{th} embodiment is any combination of the first 27 embodiments, wherein the thermoplastic polyurethane comprises a visible transmission, as determined according to reference test ASTM D1003, of from about 80% to about 100%.

A 29^{th} embodiment is any combination of the first 28 embodiments, wherein the thermoplastic polyurethane comprises a thermomechanical analysis (TMA) peak of from about 85° C. to about 90° C.

In another aspect, a first embodiment is a laminate, comprising: a first optically transparent outer sheet; a second optically transparent outer sheet; and an interlayer comprising thermoplastic polyurethane and functional elements disposed in the thermoplastic polyurethane, wherein the functional elements comprise quantum dots in an amount of from greater than 0 wt % to about 5 wt %, based on the total weight of the extruded thermoplastic interlayer, and wherein the extruded thermoplastic interlayer has a haze, as determined according to reference test ASTM D1003, of from greater than 0% to less than or equal to about 5%.

A second embodiment is the first embodiment, wherein the extruded thermoplastic interlayer is interposed between the first and second optically transparent outer sheets, and wherein the extruded thermoplastic interlayer is configured to adhere the first and second optically transparent outer sheets with one another.

A third embodiment is any combination of the first two embodiments, wherein each of the first and second optically transparent outer sheets is a glass sheet.

A 4^{th} embodiment is any combination of the first 3 embodiments, wherein each of the first and second optically transparent outer sheets is a polycarbonate sheet.

A 5^{th} embodiment is any combination of the first 4 embodiments, wherein the laminate exhibits a quantum yield, as determined according to reference test ASTM E2719, of from about 50% to about 90%.

A 6^{th} embodiment is any combination of the first 5 embodiments, wherein the laminate exhibits a quantum yield, as determined according to reference test ASTM E2719, of from about 70% to about 80%.

In another aspect, a first embodiment is a window, comprising the laminate of any of the above embodiments.

In another aspect, a first embodiment is a laminated glazing unit, comprising: a first optically transparent outer sheet; a second optically transparent outer sheet; an interlayer comprising thermoplastic polyurethane and functional elements disposed in the thermoplastic polyurethane, wherein the functional elements comprise quantum dots in an amount of from greater than 0 wt % to about 5 wt %, based on the total weight of the extruded thermoplastic interlayer, and wherein the extruded thermoplastic interlayer has a haze, as determined according to reference test ASTM D1003, of from greater than 0% to less than or equal to about 5%; and a photovoltaic cell operably coupled with the laminate.

A second embodiment is the first embodiment, wherein the photovoltaic cell is disposed adjacent an end portion of the laminate.

What is claimed is:

1. An extruded thermoplastic interlayer, comprising a thermoplastic polyurethane and functional elements disposed in the thermoplastic polyurethane, wherein the functional elements comprise quantum dots in an amount of greater than about 0 wt % to about 5 wt %, based on the total weight of the extruded thermoplastic interlayer, and wherein the extruded thermoplastic interlayer has a haze, as determined according to reference test ASTM D1003, of from greater than 0% to less than or equal to about 5%.

2. The extruded thermoplastic interlayer of claim 1, wherein the extruded thermoplastic interlayer has a haze of from greater than 0% to less than 2%.

3. The extruded thermoplastic interlayer of claim 1, wherein the extruded thermoplastic interlayer has a thickness of from about 254 μm to about 1524 μm.

4. The extruded thermoplastic interlayer of claim 1, wherein the quantum dots are present in an amount of from greater than 0 wt % to about 2 wt %, based on the total weight of the extruded thermoplastic interlayer.

5. The extruded thermoplastic interlayer of claim 1, wherein the quantum dots are present in an amount of from greater than or equal to 0.1 wt % to about 1.0 wt %, based on the total weight of the extruded thermoplastic interlayer.

6. The extruded thermoplastic interlayer of claim 1, wherein the extruded thermoplastic interlayer exhibits visible light transmission, as measured according to reference test ASTM-D1003, of greater than or equal to 10%.

7. The extruded thermoplastic interlayer of claim 1, wherein the extruded thermoplastic interlayer exhibits visible light transmission, as measured according to reference test ASTM-D1003, of greater than or equal to 60%.

8. The extruded thermoplastic interlayer of claim 1, wherein the thermoplastic polyurethane comprises a polyether-based thermoplastic polyurethane.

9. The extruded thermoplastic interlayer of claim 1, wherein the thermoplastic polyurethane comprises a tensile strength, as determined according to reference test ASTM D412, of from about 40 MPa to about 60 MPa.

10. The extruded thermoplastic interlayer of claim 1, wherein the thermoplastic polyurethane comprises an elongation at break, as determined according to reference test ASTM D412, of from about 450% to about 500%.

11. The extruded thermoplastic interlayer of claim 1, wherein the thermoplastic polyurethane comprises a 100% modulus, as determined according to reference test ASTM D412, of from about 3 MPa to about 4 MPa.

12. The extruded thermoplastic interlayer of claim 1, wherein the thermoplastic polyurethane comprises a tear strength, as determined according to reference test ASTM D624, of from about 50 kN/m to about 60 kN/m.

13. The extruded thermoplastic interlayer of claim 1, wherein the thermoplastic polyurethane comprises a glass transition temperature (Tg), as determined with a differential scanning calorimeter (DSC), of from about −65° C. to about −55° C.

14. The extruded thermoplastic interlayer of claim 1, wherein the thermoplastic polyurethane comprises a refractive index, as determined according to reference test ASTM D542-95, of from about 1 to about 2, about 1.25 to about 1.75.

15. The extruded thermoplastic interlayer of claim 1, wherein the thermoplastic polyurethane comprises a yellow index, as determined according to reference test ASTM D1925, of less than or equal to about 1.5%.

16. The extruded thermoplastic interlayer of claim 1, wherein the thermoplastic polyurethane comprises a thermomechanical analysis (TMA) peak of from about 85° C. to about 90° C.

17. A laminate, comprising:
a first optically transparent outer sheet;
a second optically transparent outer sheet; and
an interlayer comprising a thermoplastic polyurethane and functional elements disposed in the thermoplastic polyurethane, wherein the functional elements comprise quantum dots in an amount of from greater than 0 wt % to about 5 wt %, based on the total weight of the extruded thermoplastic interlayer, and wherein the extruded thermoplastic interlayer has a haze, as determined according to reference test ASTM D1003, of from greater than 0% to less than or equal to about 5%.

18. The laminate of claim 17, wherein the extruded thermoplastic interlayer is interposed between the first and second optically transparent outer sheets, and wherein the extruded thermoplastic interlayer is configured to adhere the first and second optically transparent outer sheets with one another.

19. The laminate of claim 17, wherein the laminate exhibits a quantum yield, as determined according to reference test ASTM E2719, of from about 50% to about 90%.

20. A laminated glazing unit, comprising:
a first optically transparent outer sheet;
a second optically transparent outer sheet;
an interlayer comprising a thermoplastic polyurethane and functional elements disposed in the thermoplastic polyurethane, wherein the functional elements comprise quantum dots in an amount of from greater than 0 wt % to about 5 wt %, based on the total weight of the extruded thermoplastic interlayer, and wherein the extruded thermoplastic interlayer has a haze, as determined according to reference test ASTM D1003, of from greater than 0% to less than or equal to about 5%; and a photovoltaic cell operably coupled with the laminate.
